(19) United States
(12) Patent Application Publication
(10) Pub. No.: US 2013/0231866 A1
(43) Pub. Date: Sep. 5, 2013

(54) WEATHER MONITORING SYSTEM AND STREETLAMP SYSTEM USING SAME

(71) Applicants: CHI-CHIH WANG, Tu-Cheng (TW); TZU-TE WANG, Tu-Cheng (TW); KAI-CHIANG YANG, Tu-Cheng (TW); WAN-YING LIAO, Shenzhen City (CN)

(72) Inventors: CHI-CHIH WANG, Tu-Cheng (TW); TZU-TE WANG, Tu-Cheng (TW); KAI-CHIANG YANG, Tu-Cheng (TW); WAN-YING LIAO, Shenzhen City (CN)

(21) Appl. No.: 13/661,047

(22) Filed: Oct. 26, 2012

(30) Foreign Application Priority Data
Mar. 2, 2012 (CN) 201210051929.8

(51) Int. Cl. G01W 1/00

(52) U.S. Cl. 702/3

(57) ABSTRACT

A weather monitoring system includes a plurality of weather stations located at different regions. Each weather station includes a processor; a power controller to provide power for the weather station; a sensor to detect weather conditions of the region where the weather station is, and transmit the weather condition to the processor; an emitter to transmit the weather conditions to other weather stations; a receiver to receive the weather conditions from the other weather stations; and a display device to display the weather conditions. A streetlamp system having the weather monitoring system is also provided.

### BACKGROUND

1. Technical Field

The disclosure generally relates to a weather monitoring system, especially a weather monitoring system which can report weather information instantly, and a streetlamp system using the weather monitoring system.

2. Description of Related Art

Weather conditions are closed to people's life. Before going shopping or travelling, people may concern the weather conditions of that area. Generally, people obtain weather information from a weather bureau. However, the information from the weather bureau is not instantly reported. Therefore, people can not know exactly the weather conditions in predetermined regions.

What is needed, therefore, is a weather monitoring system and a streetlamp system using the weather monitoring system which can overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of a weather monitoring system in accordance with one embodiment of the disclosure.

FIG. 2 is a schematic view of a weather station in FIG. 1.

FIG. 3 is a schematic view of a humidity sensor in FIG. 2.

FIGS. 4-5 are schematic views showing a working process of a rainfall sensor in FIG. 2.

FIG. 6 is a schematic view of a streetlamp system in accordance with one embodiment of the disclosure.

### DETAILED DESCRIPTION

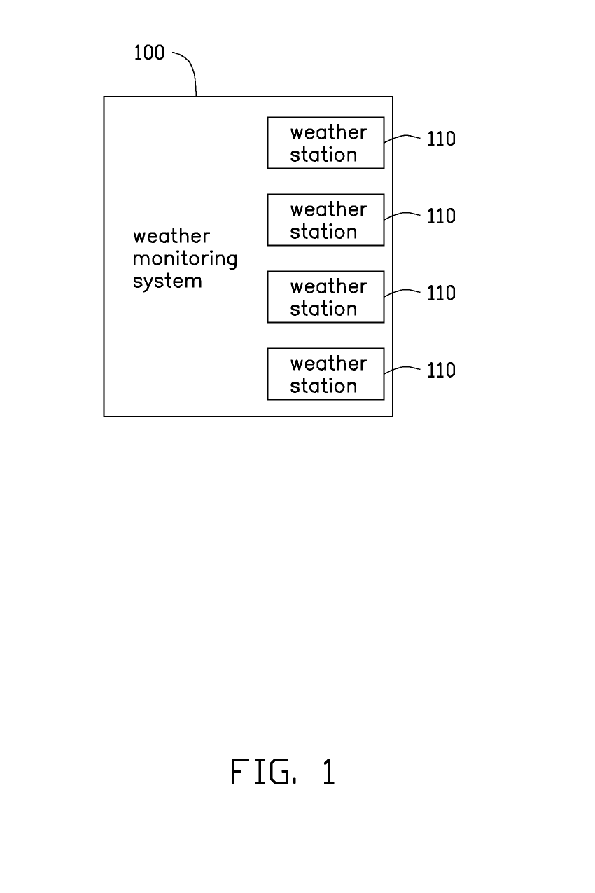

Referring to FIG. 1, a weather monitoring system 100 in accordance with one embodiment of the disclosure is shown. The weather monitoring system 100 includes a plurality of weather stations 110 located at different regions.

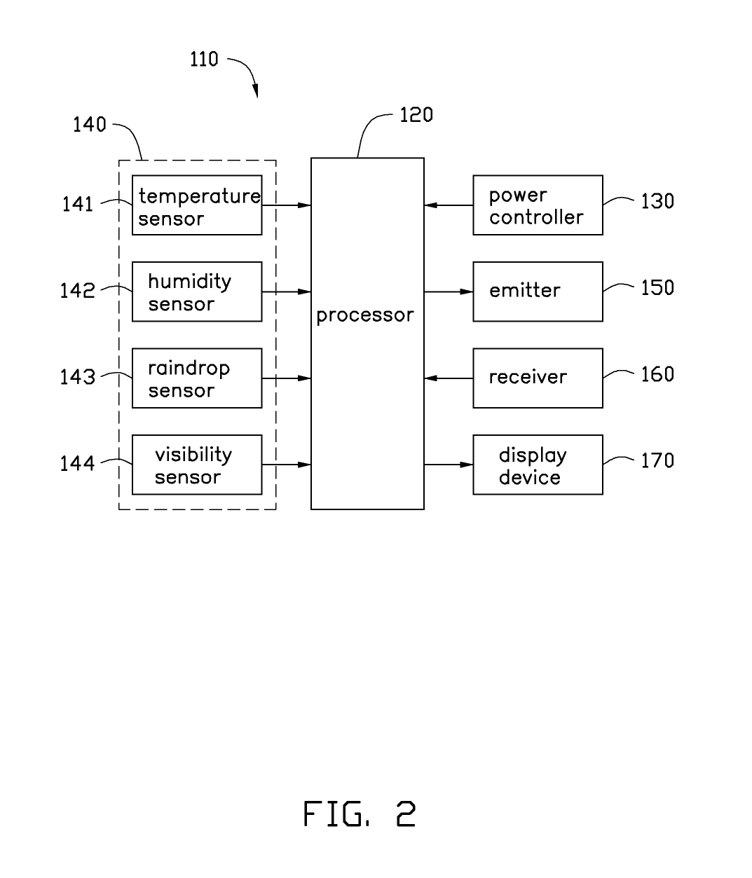

Referring also to FIG. 2, each of the weather station 110 includes a processor 120, a power controller 130 electrically connected with the processor 120, a sensor 140, an emitter 150, a receiver 160 and a display device 170.

The power controller 130 is electrically connected with external power source to provide power for the weather station 110.

The sensor 140 is configured to detect weather conditions of the regions where the weather stations 110 are. The weather conditions include temperature, humidity, rainfall and visibility of atmosphere. In this embodiment, the sensor 140 includes a temperature sensor 141, a humidity sensor 142 and a rainfall sensor 143. The temperature sensor 141 is a thermistor. The thermistor has an electrical resistance changeable according to temperature of environment. Therefore, the temperature is determined by measuring the electrical resistance of the thermistor. The humidity sensor 142 is selected from one of a humidity sensitive resistor and a humidity sensitive capacitor. The humidity sensitive resistor has an electrical resistance changeable according to humidity of environment. Therefore, the humidity of environment can be determined by measuring the electrical resistance of the humidity sensitive resistor. Similarly, the humidity sensitive capacitor has an electrical capacitance changeable according to the humidity of environment, and the humidity can be determined by measuring the electrical capacitance of the humidity sensitive capacitor.

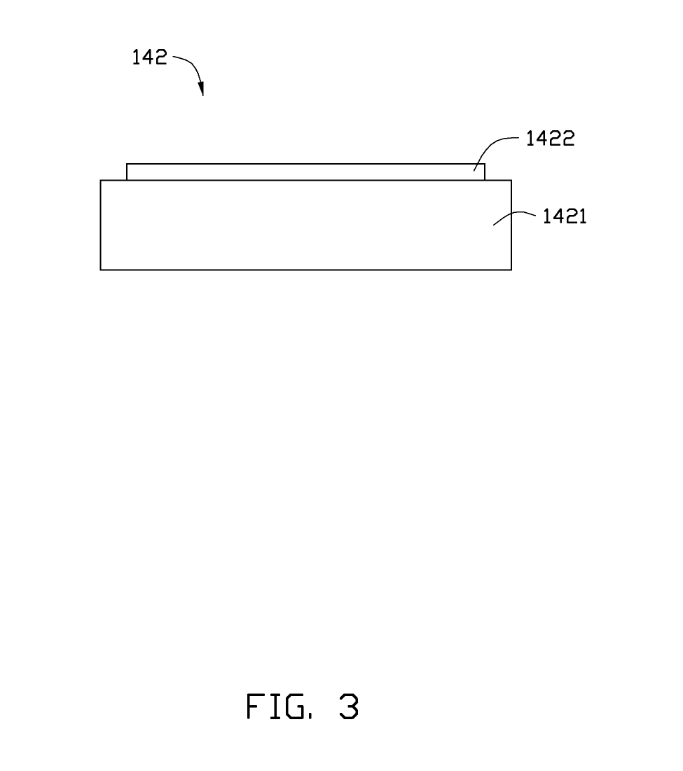

Referring also to FIG. 3, the humidity sensor 142 is a humidity sensitive resistor, which includes a substrate 1421 and a polymer film 1422 formed on the substrate 1421. The polymer film 1422 is made of a material selected from electrolyte salts, metal oxides and hygroscopic resin. The polymer film 1422 absorbs moisture in the atmosphere and changes its electrical resistance accordingly. Therefore, the humidity of atmosphere can be determined by measuring the electrical resistance of the polymer film 1422.

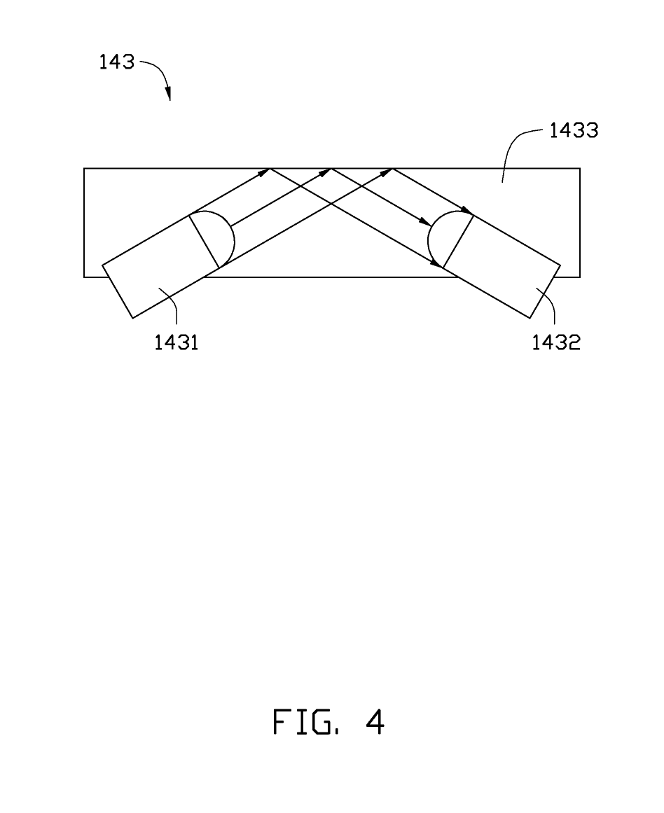

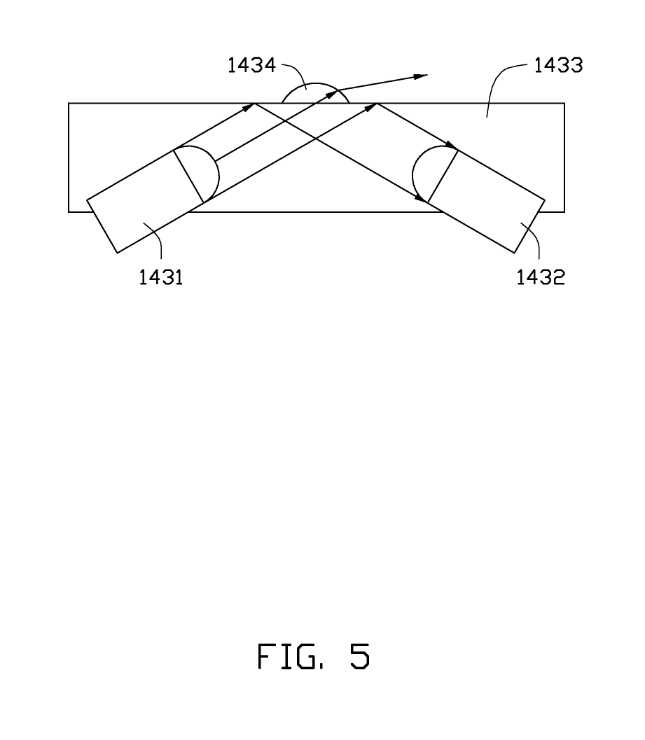

Referring to FIGS. 4-5, the rainfall sensor 143 is configured to obtain an amount of rainfall in a given time. The rainfall sensor 143 includes a light emitting diode 1431, a photodiode 1432 and a transparent glass 1433. The light emitting diode 1431 and the photodiode 1432 are positioned at an inner side of the transparent glass 1433, and an outer side of the transparent glass 1433 is exposed to outer environment. The light emitting diode 1431 is positioned at an angle with the outer surface of the transparent glass 1433 to achieve that light from the light emitting diode 1431 is totally reflected by the outer surface of the transparent glass 1433 and received by the photodiode 1432. When it is raining, a raindrop 1434 is attached to the outer surface of the transparent glass 1433. The raindrop 1434 breaks down the totally reflection of light in the outer surface of the transparent glass 1433 and reduces light being received by the photodiode 1432. Therefore, the amount of rainfall can be determined by measuring a light intensity being received by the photodiode 1432. Preferably, a screen wiper is formed on the outer surface of the transparent glass 1433 to remove the raindrop after a predetermined time.

In this embodiment, the sensor module 140 further includes a visibility sensor 144. The visibility sensor 144 determines a visibility of atmosphere by measuring a dispersal of an infrared light in atmosphere.

The emitter 150 and the receiver 160 are electrically connected with the processor 120. The emitter 150 is configured to transmit the weather conditions to the other weather stations 110. The receiver 160 is configured to receive the weather conditions transmitted by the other weather stations 110. In this embodiment, the emitter 150 is communicated with the receiver 160 by a wireless network such as a GPRS (general packet radio service). Furthermore, the weather stations 110 can also transmit the weather conditions to a weather bureau by the emitter 150 and receives weather information forecasted by the weather bureau by the receiver 160.

The display device 170 is configured to display the weather conditions detected by the senor 140. Furthermore, the receiver 160 receives the weather conditions from the other weather stations 110 and transmits to the display device 170. That is, in any one of the weather stations 110, users can look over the weather conditions of all the regions having the weather stations 110.

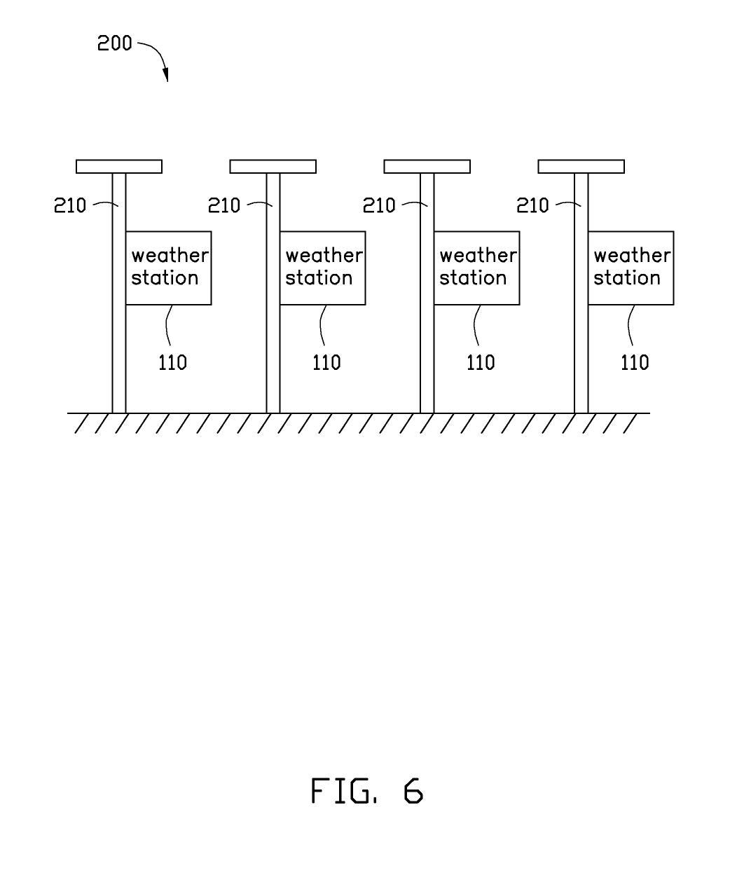

The weather stations 110 can be located at a streetlamp to form a streetlamp system. Referring to FIG. 6, the streetlamp system 200 includes a plurality of streetlamps 210. The streetlamps 210 is located at different regions. The weather stations 110 are attached to the streetlamps 210, respectively, therefore detecting and displaying the weather conditions of the regions.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A weather monitoring system, comprising:
a plurality of weather stations, located at different regions, each weather station comprising:
a processor;
a power controller to provide power for the weather station;
a sensor electrically connected with the processor, the sensor being configured to detect weather conditions of the region where the weather station is, and transmit the weather condition to the processor;
an emitter electrically connected with the processor for transmitting the weather conditions to other weather stations;
a receiver electrically connected with the processor for receiving the weather conditions from the other weather stations; and
a display device electrically connected with the processor for displaying the weather conditions.

2. The weather monitoring system of claim 1, wherein the sensor comprises a temperature sensor to determine a temperature of outer environment.

3. The weather monitoring system of claim 1, wherein the temperature sensor is a thermistor, the thermistor has an electrical resistance changeable in accordance with the temperature of environment, and the temperature of environment is determined by measuring the electrical resistance of the thermistor.

4. The weather monitoring system of claim 1, wherein the sensor comprises a humidity sensor to determine a humidity of atmosphere.

5. The weather monitoring system of claim 4, wherein the humidity sensor is a humidity sensitive resistor, the humidity sensitive resistor has an electrical resistance changeable in accordance with the humidity of atmosphere, and the humidity of atmosphere is determined by measuring the electrical resistance of the humidity sensitive resistor.

6. The weather monitoring system of claim 5, wherein the humidity sensitive resistor comprises a substrate and a polymer film formed on the substrate, an electrical resistance of the polymer film is changeable in accordance with the humidity of atmosphere.

7. The weather monitoring system of claim 6, wherein the polymer film is made of a material selected from a group consisting of electrolyte salts, metal oxides and hygroscopic resins.

8. The weather monitoring system of claim 4, wherein the humidity sensor is a humidity sensitive capacitor, the humidity sensitive capacitor has an electrical capacitance changeable in accordance with the humidity of atmosphere, and the humidity of atmosphere is determined by measuring the electrical capacitance of the humidity sensitive capacitor.

9. The weather monitoring system of claim 1, wherein the sensor comprises a rainfall sensor, the rainfall sensor comprises a light emitting diode, a photodiode, and a transparent glass, the light emitting diode and the photodiode are formed at an inner surface of the transparent glass, an outer surface of the transparent glass are exposed to outer environment, the light emitting diode is positioned at an angle with the outer surface of the transparent glass to achieve that light from the light emitting diode is totally reflected by the outer surface of the transparent glass and received by the photodiode, when it is raining, a raindrop is attached to the outer surface of the transparent glass, the raindrop breaks down the totally reflection of light in the outer surface of the transparent glass and reduces light being received by the photodiode, therefore the amount of rainfall can be determined by measuring a light intensity being received by the photodiode.

10. The weather monitoring system of claim 1, wherein the sensor module comprises a visibility sensor to determine the visibility of atmosphere.

11. A streetlamp system, comprising:
a plurality of streetlamps being located at different regions; and
a weather monitoring systems, comprising:
a plurality of weather stations being located at the streetlamps respectively, each weather station comprising:
a processor;
a power controller to provide power for the weather station;
a sensor electrically connected with the processor, the sensor being configured to detect weather conditions of the region where the weather station is, and transmit the weather condition to the processor;
an emitter electrically connected with the processor for transmitting the weather conditions to other weather stations;
a receiver electrically connected with the processor for receiving the weather conditions from the other weather stations; and
a display device electrically connected with the processor for displaying the weather conditions.

12. The streetlamp system of claim 11, wherein the sensor comprises a temperature sensor to determine a temperature of outer environment.

13. The streetlamp system of claim 11, wherein the temperature sensor is a thermistor, the thermistor has an electrical resistance changeable in accordance with the temperature of environment, and the temperature of environment is determined by measuring the electrical resistance of the thermistor.

14. The streetlamp system of claim 11, wherein the sensor comprises a humidity sensor to determine a humidity of atmosphere.

15. The streetlamp system of claim 14, wherein the humidity sensor is a humidity sensitive resistor, the humidity sensitive resistor has an electrical resistance changeable in accordance with the humidity of atmosphere, and the humidity of atmosphere is determined by measuring the electrical resistance of the humidity sensitive resistor.

16. The streetlamp system of claim 15, wherein the humidity sensitive resistor comprises a substrate and a polymer film formed on the substrate, an electrical resistance of the polymer film is changeable in accordance with the humidity of atmosphere.

17. The streetlamp system of claim 16, wherein the polymer film is made of a material selected from a group consisting of electrolyte salts, metal oxides and hygroscopic resins.

18. The streetlamp system of claim 14, wherein the humidity sensor is a humidity sensitive capacitor, the humidity sensitive capacitor has an electrical capacitance changeable in accordance with the humidity of atmosphere, and the humidity of atmosphere is determined by measuring the electrical capacitance of the humidity sensitive capacitor.

19. The streetlamp system of claim 11, wherein the sensor comprises a rainfall sensor, the rainfall sensor comprises a light emitting diode, a photodiode, and a transparent glass, the light emitting diode and the photodiode are formed at an inner surface of the transparent glass, an outer surface of the transparent glass are exposed to outer environment, the light emitting diode is positioned at an angle with the outer surface of the transparent glass to achieve that light from the light emitting diode is totally reflected by the outer surface of the transparent glass and received by the photodiode, when it is raining, a raindrop is attached to the outer surface of the transparent glass, the raindrop breaks down the totally reflection of light in the outer surface of the transparent glass and reduces light being received by the photodiode, therefore the amount of rainfall can be determined by measuring a light intensity being received by the photodiode.

20. The streetlamp system of claim 11, wherein the sensor module comprises a visibility sensor to determine the visibility of atmosphere.
